(19) United States
(12) Patent Application Publication
(10) Pub. No.: US 2012/0156113 A1
(43) Pub. Date: Jun. 21, 2012

(54) FLUIDIC SYSTEMS, FLUID CONTAINERS AND PROCESSES FOR WASHING FLUID LINES

(75) Inventors: Michael Glauser, Adliswil (CH); Heinz Michael Hein, Huenenberg See (CH); Rainer D. Jaeggi, Thalwil (CH)

(73) Assignee: ROCHE DIAGNOSTICS OPERATIONS, INC., Indianapolis, IN (US)

(21) Appl. No.: 13/326,797

(22) Filed: Dec. 15, 2011

(30) Foreign Application Priority Data
Dec. 15, 2010 (EP) 10195180.4

(51) Int. Cl. B01L 3/00; B08B 9/027

(52) U.S. Cl. 422/504; 134/22.11

(57) ABSTRACT

A process for automatically washing fluid lines of a fluidic system for combining liquid samples with one or more reagents, the system being provided with at least one main line connected to one or more reagent lines for feeding reagents, each of which being connectable to a reagent container by a fluidic connector, at least one sample intake for intaking samples and at least one pressure actuator for generating a positive or negative pressure in the fluid lines. The process comprises one or more procedures selected from: procedure I: drawing wash fluid from a wash fluid reservoir connected to the main line into the main line and discharging wash fluid into a waste compartment for receiving waste fluid of a cleaning container connected to at least one reagent line by the fluidic connector; procedure II: drawing wash fluid from at least one fluid compartment containing wash fluid of at least one cleaning container connected to at least one reagent line by the fluidic connector into the main line and discharging wash fluid from the main line into at least one waste compartment for receiving waste fluid of the cleaning container; procedure III: drawing wash fluid from at least one fluid compartment containing wash fluid of a cleaning container connected to at least one first reagent line into the main line and discharging wash fluid from the main line into at least one waste compartment for receiving waste fluid of a cleaning container connected to at least one second reagent line being different from the at least one first reagent line.

### TECHNICAL FIELD

The present disclosure generally relates to the field of clinical analysis and medical diagnostics and, more particularly, to fluidic systems, fluid containers and processes for washing fluid lines of a fluidic system. The disclosure also relates to fluid containers for connection to reagent lines of fluidic systems.

### BACKGROUND

A strong demand for the automated analysis of liquid samples can be observed which is primarily due to the fact that there is an ongoing increase in the number of clinical analyses. Sample analysis typically involves combining the samples with one or more reagents to determine absence/presence and optionally concentration of one or more analytes contained therein.

Commercially available analyzers typically use pipetting robots for combining samples and reagents. These systems normally have many fast and nearly continuously moving parts, which may require frequent maintenance and replacement operations. Otherwise, conventional analyzers have limited flexibility with regard to the type of the analytical method and can only be operated with comparably low precision due to the variability of pipetting operations. Since reagents are exposed to the ambient air, they may have a reduced shelf life.

Due to low sample consumption, fast analysis times and high sample throughput, many efforts have been made to develop integrated fluidic systems for the automated analysis of liquid samples. U.S. Application Publication No. 2011/0189052 A1 describes an integrated fluidic system for the automated analysis of liquid samples, the disclosure of which is hereby incorporated herein by reference.

### SUMMARY

It is against the above background that the embodiments of the present invention provide certain unobvious advantages and advancements over the prior art. In particular, the inventors have recognized a need for improvements in fluidic systems, fluid containers and processes for washing fluid lines.

Although the embodiments of the present invention are not limited to specific advantages or functionality, it is noted that the present disclosure provides efficient processes for washing fluid lines of integrated fluidic systems for the automated combining of liquid samples with reagents.

According to an embodiment of the invention, a process for washing fluid lines of a fluidic system for combining liquid samples with one or more reagents is provided. The fluidic system comprises at least one main line connected to one or more reagent lines for feeding reagents to the main line, at least one sample intake for intaking samples, e.g., into the main line, and at least one pressure actuator for generating a positive or negative pressure in the fluid lines. In the system, each of the reagent lines is connectable to one reagent container containing reagent by means of a fluidic connector. In some embodiments, in the fluidic system, each of the fluid lines is operatively coupled to at least one controllable fluid valve, adapted to inhibit or release fluid flow in the fluid line. In some embodiments, each of the reagent lines includes at least one controllable line valve.

According to an embodiment of the invention, the process for washing fluid lines comprises the following steps of one or more procedures, selected from the following group of procedures.

According to a first procedure (I), the process for washing fluid lines of the fluidic system comprises steps of drawing wash fluid from a wash fluid reservoir connected to the main line via a fluidic connection other than (different from) the reagent lines into the main line and discharging wash fluid into a waste compartment for receiving waste fluid of a cleaning container connected to at least one reagent line by the fluidic connector. In some embodiments, the process includes a step of releasing fluid flow between the main line and the reagent line connected to the cleaning container by means of a controllable fluid valve which is operatively coupled to the reagent line so as to allow wash fluid to be discharged into the waste compartment of the cleaning container. In some embodiments, the process comprises a step of connecting the cleaning container to at least one reagent line by means of the fluidic connector. In some embodiments, the process comprises a step of disconnecting at least one reagent container from a reagent line and connecting the cleaning container to the reagent line by means of the fluidic connector, i.e., replacing at least one reagent container by the cleaning container. In some embodiments, an empty reagent container is used as cleaning container.

According to a second procedure (II), the process for washing fluid lines of the fluidic system comprises steps of drawing wash fluid from at least one fluid compartment containing wash fluid of at least one cleaning container connected to at least one reagent line into the main line and discharging wash fluid from the main line into at least one waste compartment for receiving waste fluid of the cleaning container. In some embodiments, the process includes a step of releasing fluid flow between the main line and the reagent line to which the cleaning container is connected by means of a controllable fluid valve which is operatively coupled to the reagent line so as to allow wash fluid to be drawn from the fluid compartment into the main line and to be discharged from the main line into the waste compartment. In some embodiments, the process comprises a step of connecting the cleaning container to at least one reagent line. In some embodiments, the process comprises a step of disconnecting at least one reagent container from a reagent line and connecting the cleaning container to the reagent line, i.e., replacing at least one reagent container by the cleaning container. In some embodiments, wash fluid is drawn from the at least one fluid compartment into the main line until the wash fluid compartment is empty and used wash fluid is discharged into the at least one empty fluid compartment to be used as waste compartment for receiving waste fluid.

According to a third procedure (III), the process for washing fluid lines of the fluidic system comprises steps of drawing wash fluid from at least one fluid compartment containing wash fluid of a cleaning container connected to at least one first reagent line into the main line and discharging wash fluid from the main line into at least one waste compartment for receiving waste fluid of a cleaning container connected to at least one second reagent line being different from the at least one first reagent line. In some embodiments, the process includes a step of releasing fluid flow between the main line and the first cleaning container container-connected and second cleaning container-connected reagent lines by means of fluid valves operatively coupled thereto so as to allow that wash fluid can be drawn from the fluid compartment into the main line and that wash fluid can be discharged from the main line into the waste compartment. In some embodiments, the process comprises a step of connecting the first cleaning container to at least one first reagent line and to connect the at least one second cleaning container to at least one second reagent line. In some embodiments, the process comprises a step of disconnecting at least two reagent containers from reagent lines and connecting the first and second cleaning containers to these reagent lines, i.e., to replace the reagent containers by the first and second cleaning containers.

In some embodiments of the process according to the second and third procedures, the process comprises steps of drawing wash fluid from a wash fluid reservoir connected to the main line via a fluidic connection other than (different from) the reagent lines into the main line and discharging wash fluid into at least one waste compartment of the cleaning container.

In some embodiments of the process according to the second and third procedures, plural wash fluids different with respect to each other contained in plural fluid compartments of one or more cleaning containers are successively drawn into the main line.

In some embodiments of the process according to the first to third procedures, the process comprises a step of discharging wash fluid through the sample intake. Specifically, in some embodiments, the process includes a step of releasing fluid flow between the main line and the sample intake by means of a fluid valve operatively coupled to the sample intake so as allow that wash fluid can be discharged from the main line through the sample intake.

In some embodiments of the process according to the first to third procedures, at least one reagent container connected to one reagent line is automatically replaced by one cleaning container.

According to another embodiment of the invention, another process for washing fluid lines of a fluidic system for combining liquid samples with one or more reagents as described above is provided. Accordingly, the process comprises the following steps of connecting at least one cleaning container provided with at least one fluid compartment containing wash fluid to at least one reagent line, drawing wash fluid from the fluid compartment into the main line and discharging wash fluid from the main line through a fluid waste port of the main line.

According to yet another embodiment of the invention, a cleaning container for connection by at least one fluidic connector to at least one reagent line of a fluidic system for combining liquid samples with reagents as described above is provided. The cleaning container comprises at least one waste compartment for receiving waste fluid and/or at least one fluid compartment containing wash fluid. It further contains at least one container-sided connector part, adapted for connection to a reagent line-sided connector part of the reagent line for forming the fluidic connector.

In some embodiments, the cleaning container comprises at least one controllable or non-controllable fluid valve, adapted to release or inhibit fluid flow between the reagent line and one or more compartments in one or both flow directions. In some embodiments, the cleaning container comprises at least one fluid compartment containing wash fluid and a bi-directionally operable fluid valve adapted to selectively control fluid flow in either one of two flow directions so that the at least one empty fluid compartment can be used as waste compartment for receiving waste fluid.

In some embodiments, the cleaning container comprises a septum closing a fluid opening wherein the septum is adapted to be broken by a protruding element of the reagent line-sided connector part. Specifically, in some embodiments, the septum is arranged nearer to the fluid opening than a septum of a similar container-sided connector part of a reagent container for connection to the reagent line.

According to still yet another embodiment of the invention, a fluidic system for combining liquid samples with one or more reagents is provided.

The fluidic system can, e.g., be used for analyzing liquid samples. Specifically, in some embodiments, the fluidic system is adapted for analyzing liquid samples. Although the fluidic system is particularly suitable in (bio-)chemical applications including in-vitro diagnostics it will also be useful with a wide variety of non-(bio-)chemical applications. In some embodiments, the fluidic system can be used for diagnostic assays such as clinical-chemistry assays and immunoassays. Typical diagnostic assays comprise the qualitative and/or quantitative analysis of analytes such as albumin, ALP (alkaline phosphatase), ALT (alanine aminotransferase), ammonia, amylase, aspartat, aminotransferase, bicarbonate, bilirubin, calcium, cardiac markers, cholesterol, creatinine kinase, D-dimer, ethanol, g-glutamyltransferase, glucose, HBA1c (haemoglobin A1c), HDL-cholesterol, iron, lactate, lactate dehydrogenase, LDL-cholesterol, lipase, magnesium, phosphorus inorganic, potassium, sodium, total protein, triglycerides, UREA, and uric acid. This list is not exhaustive.

Specifically, the fluidic system of this embodiment of the present invention comprises a main line for conveying liquid fluids connected to a wash fluid reservoir and plural reagent lines connected to the main line for feeding reagents to the main line, wherein each of the reagent lines is connectable to a reagent container containing reagent by a fluidic connector. The system further comprises at least one sample intake directly or indirectly connected to the main line for feeding samples, e.g., into the main line. In some embodiments of the fluidic system, each of the fluid lines is coupled to at least one controllable fluid valve, adapted to inhibit or release fluid flow in the fluid line. Specifically, in some embodiments, each of the fluid lines includes one fluid valve. The system yet further comprises at least one pressure actuator which is adapted for generating a positive or negative pressure in the fluid lines. Furthermore, the system comprises one or more reagent containers containing reagents, wherein each of the reagent containers is connected to one reagent line by one fluidic connector. The system further comprises at least one cleaning container provided with at least one waste compartment for receiving waste fluid connected to at least one reagent line by the fluidic connector. The system yet further comprises a controller for controlling the activity of components which require control such as the pressure actuator and fluid valves, wherein the controller is set up to control activity of the pressure actuator and fluid valves in a manner to draw wash fluid from the wash fluid reservoir into the main line and to discharge wash fluid from the main line into the waste compartment.

According to yet still another embodiment of the present invention, another fluidic system for combining liquid samples with one or more reagents is proposed. Specifically, the fluidic system comprises a main line for conveying liquid fluids and plural reagent lines connected to the main line for feeding reagents to the main line, wherein each of the reagent lines is connectable to a reagent container containing reagent by a fluidic connector. The system further comprises at least one sample intake which is directly or indirectly connected to the main line for feeding samples, e.g., into the main line. In some embodiments of the fluidic system, each of the fluid lines is coupled to at least one controllable fluid valve, adapted to inhibit or release fluid flow in the fluid line. Specifically, in some embodiments, each of the fluid lines includes the fluid valve. The system yet further comprises at least one pressure actuator which is adapted for generating a positive or negative pressure in the fluid lines. Furthermore, the system comprises one or more reagent containers containing reagents, wherein each of the reagent containers is connected to one reagent line by one fluidic connector. The system further comprises at least one cleaning container provided with at least one waste compartment for receiving waste fluid and at least one wash compartment containing wash fluid connected to at least one reagent line. The system yet further comprises a controller set up to control activity of the pressure actuator and fluid valves in a manner to draw wash fluid from the wash compartment into the main line and to discharge wash fluid from the main line into the waste compartment. In some embodiments of the fluidic system the main line is connected to a wash fluid reservoir containing wash fluid and wherein the controller is set up to draw wash fluid from the wash fluid reservoir into the main line and to discharge wash fluid from the main line into at least one waste compartment.

In some embodiments of the above-described fluidic systems, the cleaning container comprises plural fluid compartments containing wash fluids different with respect to each other, wherein the controller is set up to selectively draw the wash fluids into the main line.

In some embodiments of the above-described fluidic systems, the main line is connected to a waste fluid port, wherein the controller is set up to discharge wash fluid through the waste fluid port.

In some embodiments of the above-described fluidic systems, the system comprises an automated positioning mechanism, adapted for positioning individual containers, wherein the controller is set up to replace at least one reagent container connected to one reagent line by the cleaning container.

These and other features and advantages of the embodiments of the present invention will be more fully understood from the following detailed description taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a schematic drawing illustrating exemplary embodiments of the fluidic system of the present invention;

FIG. 2 is a schematic drawing illustrating exemplary embodiments of a cleaning container connected to one reagent line;

FIGS. 3A-3B are schematic drawings illustrating exemplary embodiments for connecting each of a cleaning container and a reagent container to one reagent line;

FIGS. 4A-4B are schematic drawings illustrating exemplary embodiments of the fluidic connector;

FIGS. 5A-5C are schematic drawings illustrating exemplary embodiments of the cleaning container;

FIGS. 6A-6B are schematic drawings illustrating different exemplary scenarios for washing fluid lines of the fluidic system;

FIG. 7 is a schematic drawing illustrating another exemplary scenario for washing fluid lines of the fluidic system;

FIG. 8 is a schematic drawing illustrating another exemplary scenario for washing fluid lines of the fluidic system;

FIGS. 9A-9C are workflow diagrams illustrating various exemplary wash processes; and

FIG. 10 is a schematic perspective view of an exemplary embodiment of the fluidic system of the present invention.

### REFERENCE LIST

1 Fluidic system

2 Main line

3 Waste fluid port

4 Receiving chamber

5 Pressure actuator

6 Connecting line

7 Sample intake

8 Reagent line

9 Reagent container

10 Set

11 Cleaning container

12 Fluid compartment

13 Waste compartment

14 Processing unit

15 Fluidic connector

16 Controller

17 Positioning mechanism

18 Housing

19 Wash fluid reservoir

20 Fluid valve

21 Container valve

22 Container duct

23 First connector portion

24 Second connector portion

25 Connector duct

26 Junction

27 Septum

28 Fluid opening

29 Gasket

30 Protruding element

31 Protrusion

32 Slot

33 Wall

34 Ball

35 Spring

36 Recess

37 Analytical unit

38 Optical detector

39 Reagent unit

30 Sample unit

41 Sample tube loading mechanism

42 Sample tube

43 Distribution unit

44 Belt

45 Rack

46 Flow-through cell

47 Connecting channel

48 Waste container

Skilled artisans appreciate that elements in the figures are illustrated for simplicity and clarity and have not necessarily been drawn to scale. For example, the dimensions of some of the elements in the figures may be exaggerated relative to other elements to help improve understanding of the embodiments of the present invention.

### DETAILED DESCRIPTION

As used herein, the term “sample” generally relates to biological and non-biological (chemical) fluids. Biological fluids such as body fluids like blood, serum, urine, saliva and cerebrospinal fluid can, e.g., be subject to analyses and assays in medical and pharmaceutical research and clinical diagnosis. Non-biological fluids can, e.g., be subject to chemical analyses and assays, e.g., drug interaction screening, environmental analysis and identification of organic substances. Samples can also be pre-processed fluids such as extracts of body fluids.

As used herein, the term “reagent” generally relates to any liquid fluid. In the more strict sense of the term, a reagent is a liquid solution containing a reactant such as a compound or agent capable of binding to or transforming one or more analytes present in a liquid sample. Accordingly, reagents may contain reactants for reaction with one or more analytes contained in the sample. Examples of reactants are enzymes, enzyme substrates, conjugated dyes, protein-binding molecules, nucleic acid binding molecules, antibodies, chelating agents, promoters, inhibitors, epitopes, antigens and catalysts. Reagents, however, can also be non-reacting fluids such as buffers, solvents and diluting fluids.

As used herein, the term “fluid line” or “line” generally relates to a flow channel configured for conveying liquid fluids and optionally gaseous fluids.

As used herein, the term “connected” generally relates to a fluidic connection which can be direct or indirect. Fluid lines connected with respect to each other can be equipped with flow regulating means such as fluid valves.

As used herein, the term “fluid valve” or “valve” generally relates to controllable or non-controllable means for regulating fluid flow. Controllable valves can be brought into one of two distinct states: a valve open state in which liquid fluid can pass through the valve and a valve closed state in which liquid fluid is inhibited to pass the valve.

Specifically, valves can, e.g., be configured as freeze-thaw valves which can selectively be brought into one of three distinct states with respect to liquid and gaseous fluids: a valve open state in which both liquid and gaseous fluids can pass through the valve, a first valve closed state in which gaseous fluid can pass through the valve but liquid fluid is blocked to pass the valve, and a second valve closed state in which both liquid and gaseous fluids are blocked to pass the valve. If not specified in more detail, a “valve closed state” of the freeze-thaw valve can be the first or the second valve closed state. Freeze-thaw valves are well-known to those of skill in the art and in the patent literature, e.g., are described in U.S. Pat. No. 6,557,575 and U.S. Pat. No. 6,311,713 B1.

As used herein, the term “positive pressure” relates to pressures greater than atmospheric (ambient) pressure and the term “negative pressure” relates to pressures less than atmospheric pressure.

In order that the embodiments of the invention may be more readily understood, reference is made to the following examples, which are intended to illustrate the invention, but not limit the scope thereof.

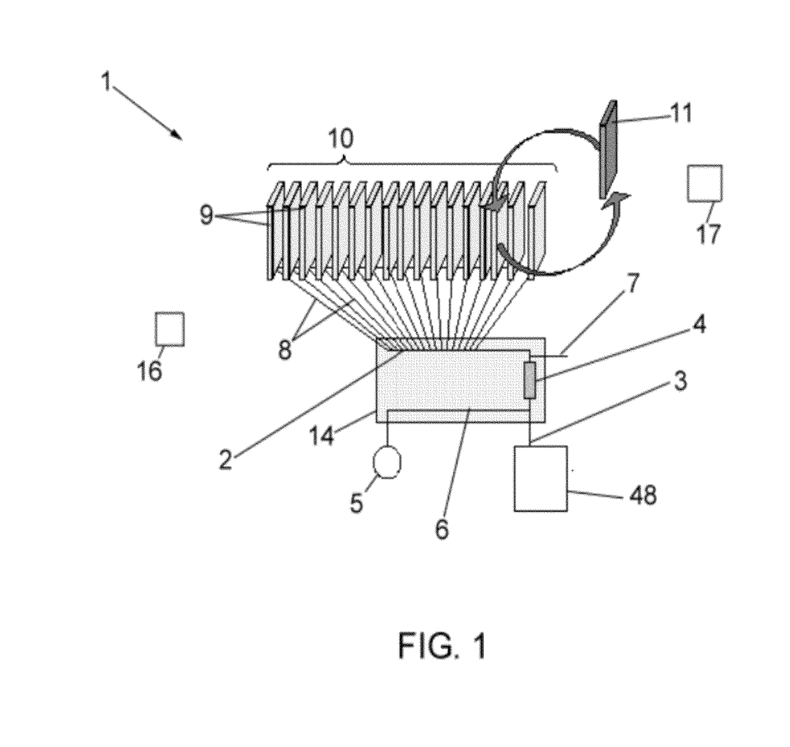

By way of illustration, specific exemplary embodiments in which the invention may be practiced are described. With particular reference to FIG. 1, exemplary embodiments of the fluidic system according to the invention, generally referred to at reference numeral 1, are explained.

Accordingly, in some embodiments, the fluidic system 1 configured as a flow-through system includes a processing unit 14 provided with a main line 2 for conveying liquid fluids which, in some embodiments, freely opens into a waste fluid container 48 for discharging waste fluid. The fluidic system 1 can, e.g., be part of a diagnostic instrument, e.g., for clinical chemistry, immunochemistry, coagulation, etc. As illustrated, the main line 2 includes a (flow-through) receiving chamber 4 for receiving liquid fluids. While only one receiving chamber 4 is illustrated for the purpose of illustration only, those of skill in the art will appreciate that more than one receiving chamber 4, e.g., in parallel arrangement with respect to each other, can be envisaged according to the specific demands of the user, in accordance with this disclosure.

In some embodiments, the receiving chamber 4 is operatively coupled to one or more detecting means related to one or more analytical methods. Specifically, in some embodiments, the receiving chamber 4 is operatively coupled to an ion-selective electrode (ISE), a biosensor such as an enzymatic-electrochemical detector, an electro-chemoluminescence detector (ECL), an optical detector, e.g., embodied as photometer to detect light emitted from reaction products contained in the receiving chamber 4 and the like (not shown).

In some embodiments, a pressure actuator 5 such as a pump is connected to the main line 2 via connecting line 6 for generating a positive or negative pressure therein. In some embodiments, the pressure actuator 5 is adapted for pumping gaseous fluids. In some embodiments, the pressure actuator 5 is adapted for pumping liquid and gaseous fluids. The pressure actuator 5 can be embodied as continuous or discontinuous pressure actuator such as, for example, a pump of the membrane pump type, syringe pump type, rotary displacement pump type and bellow pump type. While only one pressure actuator 5 is illustrated for the purpose of illustration only, those of skill in the art will appreciate that more than one pressure actuator 5 can be envisaged according to the specific demands of the user, in accordance with this disclosure.

In some embodiments, one sample intake 7 is connected to the main line 2 for feeding samples to the main line 2 and receiving chamber 4, respectively. In some embodiments, the sample intake 7 is a metallic needle. Accordingly, samples can be aspirated via the sample intake 7 into the main line 2, e.g., from a sample tube (not illustrated) by action of the pressure actuator 5. While only one sample intake 7 is illustrated for the purpose of illustration only, those of skill in the art will appreciate that more than one sample intake 7 can be envisaged according to the specific demands of the user, and in accordance with the present disclosure.

In some embodiments, in the fluidic system 1, a plurality of reagent lines 8 is connected to the main line 2 for feeding one or more reagents to the main line 2 and receiving chamber 4, respectively. In some embodiments, each of the reagent lines 8 is connected to one reagent container 9, e.g., configured as cassette containing reagent by means of one fluidic connector 15 (not further detailed in FIG. 1). Accordingly, a set 10 of plural reagent containers 9 containing one or more reagents are connected to the reagent lines 8. The reagents contained in the reagent containers 9 can be the same, similar or different with respect to each other.

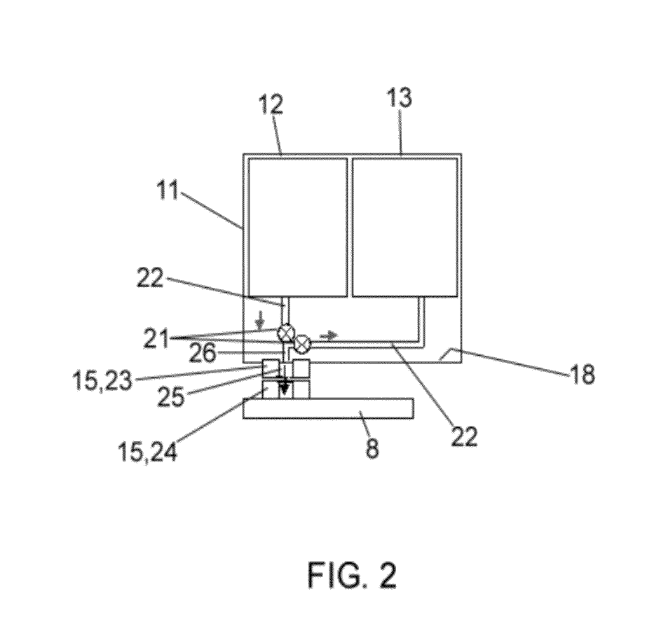

As illustrated in FIG. 1, in some embodiments, the fluidic system 1 further includes at least one cleaning container 11 provided with at least one fluid compartment 12 containing wash fluid and/or at least one waste compartment 13 for receiving used wash fluid, i.e., waste fluid. See FIG. 2. While only one cleaning container 11 is illustrated for the purpose of illustration only, those of skill in the art will appreciate that more than one cleaning container 11 can be envisaged according to the specific demands of the user, in accordance with the present disclosure.

While not illustrated, in some embodiments of the fluidic system 1, each of the reagent lines 8 is operatively coupled to at least one controllable fluid valve, adapted for inhibiting and releasing fluid flow in the reagent line 8. In some embodiments, the fluid valves are included in the reagent lines 8, e.g., adjacent the main line 2. Furthermore, in some embodiments of the fluidic system 1, the sample intake 7 is operatively coupled to at least one controllable fluid valve, adapted for inhibiting and releasing fluid flow in the sample intake 7.

With continued reference to FIG. 1, in some embodiments, the fluidic system 1 further includes an automated positioning mechanism 17 such as an automated gripping arm adapted for positioning individual containers 9, 11. Since those of skill in the art are aware of the specific function and construction of such positioning mechanism it is not necessary to elucidate it herein.

As illustrated, in some embodiments, the fluidic system 1 further includes a controller 16 set up to control washing fluid lines of the fluidic system 1. In some embodiments, the controller 16 is a programmable logic controller running a computer-readable program provided with instructions to perform operations in accordance with a process plan. The controller 16 is electrically connected to the system components which require control and/or provide information. Specifically, the controller 16 is electrically connected to the pressure actuator 5, the automated positioning mechanism 17 and the various controllable fluid valves (not illustrated). Specifically, the controller 16 is set up to control intake of samples and reagents by generating a negative pressure in the main line 2. Otherwise, as illustrated in FIG. 1, in some embodiments, the controller 16 is set up to control the positioning mechanism 17 in a manner to disconnect one reagent container 9 from a reagent line 8 and to connect one cleaning container 11 to the reagent line 8, that is to say, to replace one reagent container 9 with the cleaning container 11.

With particular reference to FIG. 2, in some embodiments, the cleaning container 11 comprises a housing 18 accommodating at least one fluid compartment 12 containing wash fluid and at least one (empty) waste compartment 13 for receiving waste fluid. The fluid compartment 12 is separated from the waste compartment 13. Specifically, in some embodiments, the fluid and waste compartments 12, 13 are connected to a first connector portion 23 by container ducts 22 unifying at junction 26. As illustrated, each of the container ducts 22 includes a container valve 21. In some embodiments, the container valve 21 is a non-controllable one-way check-valve, adapted for releasing the fluid flow in one direction and blocking the fluid flow in the reverse direction. As illustrated, the container valve 21 operatively coupled to the fluid compartment 12 releases fluid flow towards the reagent line 8 and blocks fluid flow in the reverse direction. Otherwise, the container valve 21 operatively coupled to the waste compartment 13 blocks fluid flow towards the reagent line 8 and releases fluid flow into the waste compartment 13. The first connector portion 23 can be coupled to a second connector portion 24 of the reagent line 8 for forming the fluidic connector 15 enabling fluid flow through a connector duct 25. The cleaning container 11 of FIG. 2 having an integrated wash fluid reservoir and a (empty) space for collecting used wash fluid allows plural washing cycles, each of which involving sucking out wash fluid from the fluid compartment 12 and pushing the used (contaminated) wash fluid back into the waste compartment 13.

The combined cleaning container 11 has many advantages. One major advantage is that the wash fluid can be taken back into its origin so that no additional waste has to be handled in the fluidic system 1. In the case of configuring the fluidic system 1 as a disposable analytical unit this can be of certain interest since only solid waste is generated on the analytical part and no fluid waste. The fluid compartment 12 contains a wash fluid such as a cleaning solution, e.g., sodium hydroxide solution, hydrochloric acid, sodium hypochlorite, a detergent solution, an enzyme solution, or similar chemicals. The cleaning container 11 can, e.g., be configured as a re-usable cassette intended for multiple use allowing the fluid compartment 12 to be refilled with wash fluid and the waste compartment 13 to be emptied. Alternatively, the cleaning container 11 can be configured as a disposable subject intended for single-use only. The cleaning container 11 can, e.g., be made of a chemically inert, inexpensive polymeric material such as high-density polyethylene (HDPE) and polypropylene (PP).

With continued reference to FIG. 2, in some alternative embodiments, instead of at least one fluid compartment 12 and at least one waste compartment 13, the cleaning container 11 contains at least one fluid compartment 12 filled with wash fluid but no waste compartment 13. In some yet alternative embodiments, instead of at least one fluid compartment 12 and at least one waste compartment 13, the cleaning container 11 contains at least one waste compartment 13 for receiving waste fluid but no fluid compartment filled with wash fluid. The various compartments can, e.g., be embodied as collapsible or expandable bags or pouches.

With yet continued reference to FIG. 2, the cleaning container 11 can readily be connected to one reagent line 8 by the fluidic connector 15 comprised of the first and second connector portions 23, 24. Due to a non-permanent connection of the cleaning container 11, it can be configured for easy removal from the reagent line 8 without the need of using tools.

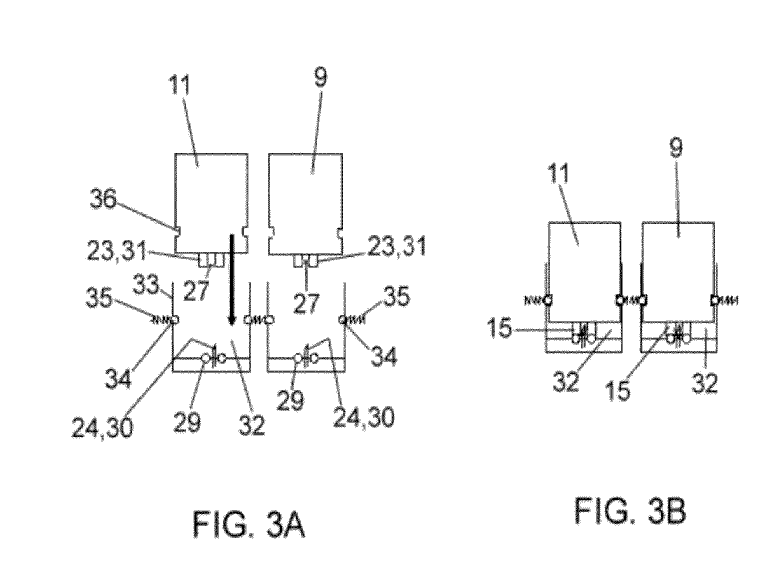

With particular reference to FIGS. 2 and 3A, in some embodiments, the first connector portion 23 includes a septum 27 located adjacent an outlet or fluid opening 28 of the connector duct 25 which, in some embodiments, as illustrated, is a hollow-cylindrical duct formed by protrusion 31 fixed to housing 18. As illustrated, in some embodiments, the protrusion 31 is configured as a ring-like pedestal. The non-broken septum 27 closes the connector duct 25. The second connector portion 24 of the reagent line 8 comprises a sharp protruding element 30 such as a needle which when approaching the cleaning container 11 can penetrate and break the septum 27 so as to open the connector duct 25.

As illustrated in FIGS. 3A and 3B, left drawings, in some embodiments, the cleaning container 11 can be mounted by means of a slot 32 formed by parallel walls 33. Specifically, the walls 33 of one slot 32 are provided with two opposing balls 34 pre-tensioned by compression springs 35 and arranged to snap into recesses 36 of the housing 18 so that the cleaning container 11 can be releasably secured within the slot 32. In secured position, the protruding element 30 penetrates the septum 27 and dips into the connector duct 25 until the protrusion 31 abuts against a gasket 29 for sealing the connector duct 25. Those of skill in the art will appreciate that the illustrated catching mechanism is only an exemplary mechanism for fixing the cleaning container 11 in the slot 32 and that any other geometry and/or fixing mechanism such as, for example, a magnetic fixation, can be envisaged according to the specific demands of the user, in accordance with the present disclosure.

With particular reference to FIGS. 3A and 3B, right drawings, illustrating mount of a reagent container 9 by the fluidic connector 15, in some embodiments, the first connector portion 23 except for the position of septum 27 and outer dimensions of the reagent container 9 are similar to the cleaning container 11. Accordingly, any reagent container 9 connected to one reagent line 8 by fluidic connector 15 can readily be replaced with the cleaning container 11.

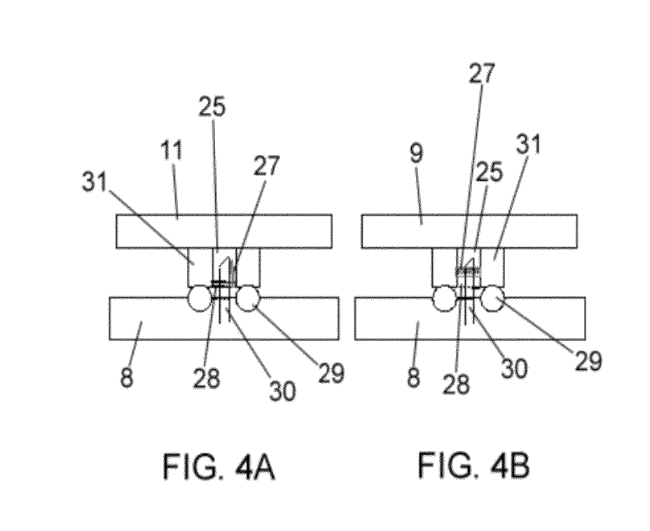

With continued reference to FIGS. 3A and 3B, right drawings, and specific reference to FIGS. 4A and 4B illustrating an enlarged detail of the fluidic connector 15, septum 27 of the cleaning container 11 is arranged nearer to the fluid opening 28 of the connector duct 25 than septum 27 of the reagent container 9. Specifically, contrary to the reagent container 9, in the cleaning container 11, septum 27 is mounted in the lowest level thereof. Accordingly, complete washing of the protruding element 30 and the whole connection area is possible. In other words, the whole connection area till gasket 29 is washable.

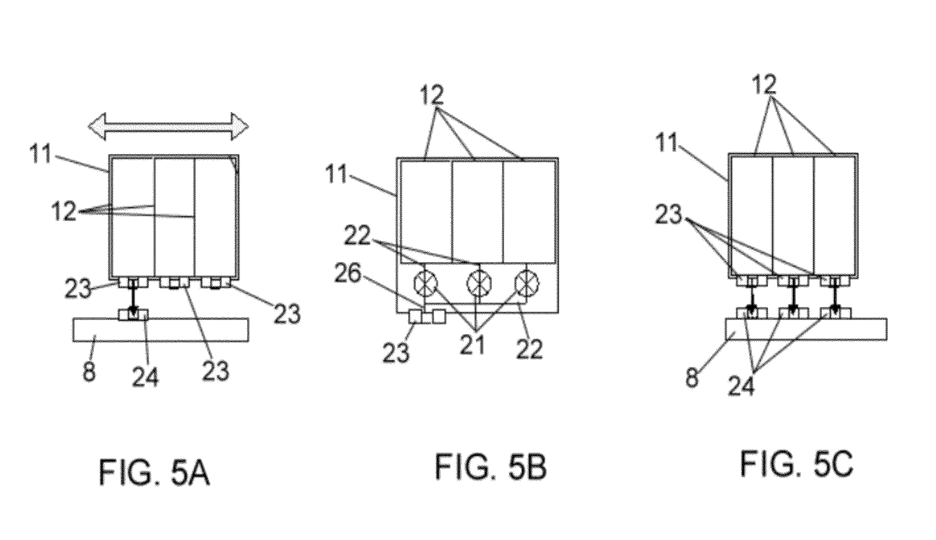

With particular reference to FIGS. 5A to 5C, another variant of the cleaning container 11 is explained. Accordingly, the cleaning container 11 comprises plural fluid compartments 12 containing wash fluid(s) which are fluidically separated with respect to each other to prevent mixing of the wash fluids. While a number of three compartments 12 is shown for the purpose of illustration only, those of skill in the art will appreciate that the cleaning container 11 can comprise a smaller or larger number of fluid compartments 12 according to the specific demands of the user, in accordance with the present disclosure. In some embodiments, the wash fluids contained in the various fluid compartments 12 are different with respect to each other configuring the cleaning container 11 as “multi-wash fluid container”.

As illustrated in FIG. 5A, in some embodiments, each of the fluid compartments 12 is connected to an individual first connector portion 23, each of which can be coupled to one second connector portion 24 of one reagent line 8. Hence, the fluid compartments 12 of the cleaning container 9 can selectively (alternatively) be connected to one reagent line 8 requiring the cleaning container 11 to be relatively moved with respect to the reagent line 8. In some embodiments, the controller 16 is set up to control activity of the positioning mechanism 17 in a manner to automatically move the cleaning container 11 to successively connect the various fluid compartments 11 to the one reagent line 8. Alternatively, the cleaning container 11 can be manually moved.

As illustrated in FIG. 5B, in some alternative embodiments, the fluid compartments 12 share one first connector portion 23 which can be coupled to one second connector portion 24 of one reagent line 8. Specifically, each fluid compartment 12 is connected to the one first connector portion 23 by means of an individual container duct 22, each of which including a container valve 21. In some embodiments, the container valve 21 is configured as a controllable fluid valve controlling fluid flow in the container duct 22. The container ducts 22 unify in junction 26. Accordingly, the wash fluids can selectively (successively) be drawn out of the cleaning container 11 by operating the respective container valve 21. In some alternative embodiments, the container valves 21 are configured as “once-open valves” which can break by pressure to be permanently open. In some embodiments, the container valves are opened one after the other, e.g., in a serial manner to successively draw wash fluid out of the cleaning container 11.

As illustrated in FIG. 5C, in some yet alternative embodiments, each of the fluid compartments 12 is connected to an individual first connector portion 23 which are arranged in a manner to be simultaneously coupled to plural second connector portions 23 of plural reagent lines 8 thus configuring a “multi-slot container”. Hence, all fluid compartments 12 of the cleaning container 11 can simultaneously be connected to plural reagent lines 8 without requiring the cleaning container 11 to be relatively moved with respect to the reagent lines 8. The cleaning container 11 thus allows simultaneous washing of more than one reagent line 8 at a time. This can particularly be useful in case the fluidic system 1 has not been used over a longer time period to perform maintenance or before a transportation event or during instrument service. The wash fluid flow can also be controlled by fluid valves arranged outside the cleaning container 11 allowing the cleaning container 11 to be produced at low cost.

As described above, the cleaning container 11 can contain several wash fluids, e.g., to wash by acidic and alkaline solutions using a same cleaning container 11. Otherwise, the cleaning container 11 can contain fluids such as buffer solutions containing detergent to wash out previously used aggressive wash fluids which could possibly interfere with the following reagent. Stated more particularly, some wash fluids such as strong acids and bases can interfere with assay reagents, e.g., by (de)-protonation, pH-change or chemical reactions with some ingredients of the assay. This may lead to a wrong assay composition and potentially compromise the result(s). Strong wash solutions are typically accordingly washed out by flushing the fluid lines with buffer or purified water.

With continued reference to FIGS. 5A to 5C, while not illustrated, in some alternative embodiments, at least one of the fluid compartments 12 is empty to serve as waste compartment 13.

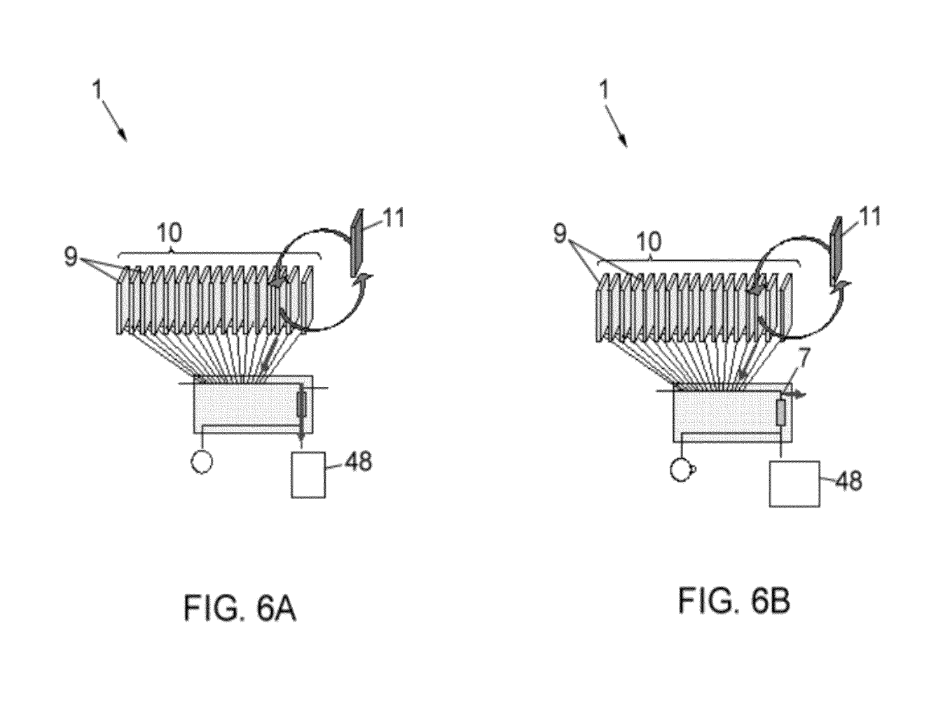

With particular reference to FIGS. 6A and 6B, different scenarios for washing fluid lines of the fluidic system 1 under control of controller 16 are exemplified. Accordingly, in a first scenario, illustrated in FIG. 6A, one reagent container 9 is taken away from one reagent line 8 and replaced by one cleaning container 11. The cleaning container 11 is secured within the slot 32 and connected to the reagent line 8 by the fluidic connector 15. In some embodiments, as illustrated, the cleaning container 11 comprises at least one fluid compartment 12 filled with wash fluid configuring the cleaning container 11 as wash fluid container. A controllable line valve (not illustrated) coupled to and included in the reagent line 8 is opened to release fluid flow between the cleaning container 11 and the reagent line 8. By generating a negative pressure in the main line 2 by means of the pressure actuator 5, wash fluid can be drawn out of the fluid compartment 12 of the cleaning container 11 into the main line 2. Afterwards, the line valve is closed and positive pressure is generated to thereby discharge the wash fluid through the waste fluid port 3 into the waste container 48. In some embodiments, the washing step is repeated until the desired cleaning quality is reached or the cleaning container 11 is empty. Specifically, in some embodiments, in case the cleaning container 11 contains plural wash fluids different with respect to each other, plural wash fluids can successively be drawn out of the cleaning container 11 which then are discharged into the waste container 48 directly connected to the main line 2. Finally, the cleaning container 11 is removed and the empty slot 32 is filled with a new reagent container 9 which is connected to the reagent line 8. Alternatively, another cleaning container 11 with one or more wash fluids different from the former ones can be connected to the reagent line 8. In some embodiments, the new reagent container 9 contains a same reagent as the previous reagent container 9. In some alternative embodiments, which can be preferred, the new reagent container 9 contains a reagent different from the reagent of the previous reagent container 9, e.g., another reagent assay type. By cleaning the reagent line 8 prior to changing the reagent, cross-contamination can advantageously be prevented.

In some alternative embodiments, not illustrated, instead of being discharged into the waste container 48, the wash fluid can also be discharged into an empty waste compartment 13 of the cleaning container 11, e.g., configured as illustrated in FIG. 2. Stated more particularly, for drawing wash fluid out of the cleaning container 11, the fluid valve is opened and negative pressure is generated in the main line 2. The wash fluid can then be discharged into the waste compartment 13 of the cleaning container 11 by opening the fluid valve and generating a positive pressure in the main line 2.

With particular reference to FIG. 6B, a further alternative scenario for washing fluid lines of the liquid system 1 is illustrated. Accordingly, after replacing one reagent container 9 by the cleaning container 11 and drawing wash fluid from the cleaning container 11 into the main line 2, the wash fluid is discharged through the sample intake 7 into another waste container (not illustrated). Hence, the sample intake 7 can readily be washed by the wash fluid.

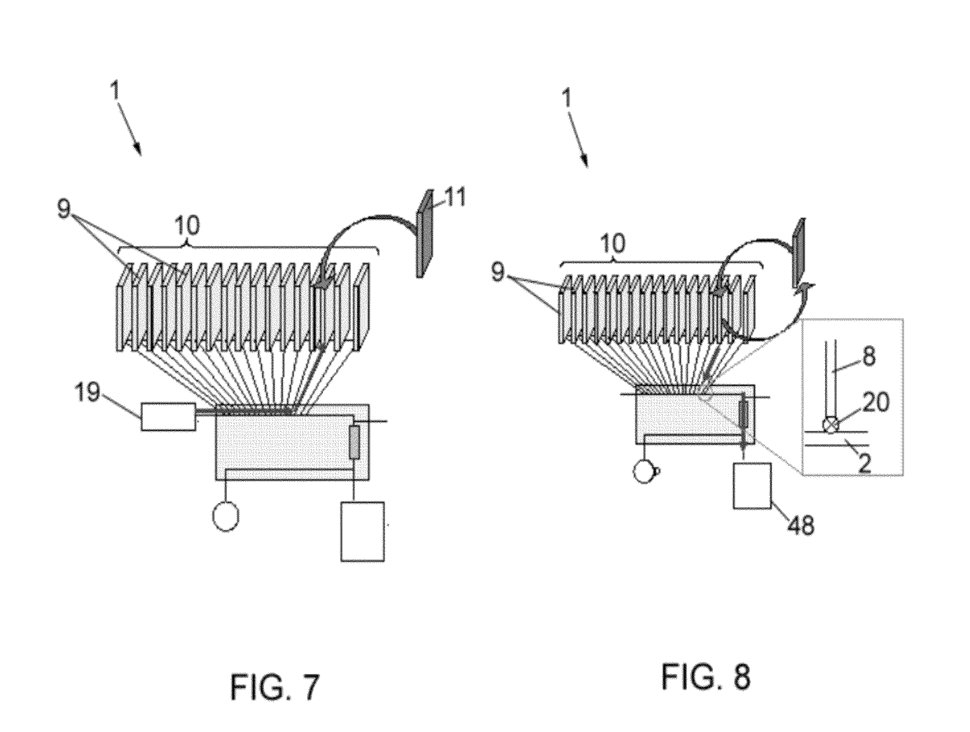

With particular reference to FIG. 7, a yet further alternative scenario for washing fluid lines of the liquid system 1 is illustrated. Accordingly, one reagent container 9 is automatically or manually replaced by one cleaning container 11 which contains an empty waste compartment 13 for receiving waste fluid but need not contain wash fluid. In the fluidic system 1, the main line 2 is connected to a wash fluid reservoir 19. The waste compartment 13 is connected to the reagent line 8 via container valve 22, e.g., configured as one-way or self-closing valve such as a septum or check-valve which prevents backflow out of the waste compartment 13. For washing, at first, a fluid valve of the reagent line 8 connected to the cleaning container 11 is closed and negative pressure is generated in the main line 2 so as to draw wash fluid into the main line 2. Afterwards, the fluid valve is opened and positive pressure is generated in the main line 2 to discharge the wash fluid into the waste compartment 13 of the cleaning container 11. Accordingly, in this scenario, the empty space of the cleaning container 11 can be filled with used wash fluid from the fluidic system 1. The washing step can be repeated until the desired cleaning quality of the liquid system 1 is obtained. Then, the cleaning container 11 is automatically or manually removed and replaced by another reagent container 9 which can contain a same, similar or different reagent with respect to the previous reagent container 9 or by another cleaning container 11. In some embodiments, the cleaning container 11 is configured as a sealed bag inside a sturdy frame, wherein the bag expands until it reaches borders of the sturdy frame while filling. In some alternative embodiments, the cleaning container 11 is an empty container with an integrated membrane which allows air to escape but holds back liquid fluid, e.g., made of polytetrafluorethylene (PTFE) tissue. In some embodiments, an empty reagent container 9 is used as cleaning container 11 provided with an empty space for receiving used wash fluid. In the latter case, the reagent container 9 can, e.g. be provided with a controllable fluid valve adapted to selectively control fluid flow in both flow directions.

With particular reference to FIG. 8, a yet further alternative scenario for washing fluid lines of the liquid system 1 is illustrated. Accordingly, one cleaning container 11 is (semi-)permanently, that is to say, for a longer time period than for one washing process, connected to one free reagent line 8. As illustrated, in some embodiments, the cleaning container 11 comprises a fluid compartment 12 containing wash fluid which can be drawn into the main line 2 to then be discharged into the waste container 48 connected to the main line 2 via a fluidic connection being different from the reagent lines 8. In some alternative embodiments, the used wash fluid is discharged from the main line 2 into an empty reagent container 9. In some yet alternative embodiments, the cleaning container 11 contains no wash fluid but only an empty waste compartment 13 for receiving used wash fluid. The wash fluid, e.g., drawn into the main line 2 from the wash fluid reservoir 19 directly connected to the main line 2, can then be discharged into the cleaning container 11. As illustrated, in some embodiments, a controllable fluid valve coupled to and included in the reagent line 8 is used to control fluid flow between the main line 2 and the cleaning container 11. The fluid valve can, e.g., be embodied as a freeze/thaw valve, but any other controllable fluid valve could be used in accordance with the present disclosure.

As illustrated by the various scenarios for washing fluid lines of the fluidic system 1, by connecting the cleaning container 11 to at least one reagent line 8, cleaning of the fluidic system 1, especially of the permanent connection part from the fluidic connector 15 to the main line 2, that is to say, of the reagent lines 8, can be performed. In particular, in the case of a reagent change, e.g., a change from an assay A to an assay B, the reagent lines 8 can be thoroughly washed so as to avoid carry-over of the old assay A to the new assay B. Hence, the risk of various types of wrong results like false analyte concentrations or even false negative or false positive results can advantageously be avoided. The cleaning containers 11 can specifically be adapted to wash the reagent lines 8, e.g., by means of a highly-effective cleaner which normally is not on-board of analytical instruments. Hence, the carry-over rate can be strongly reduced to an extent that is lower than a significant amount. Therefore, use of the cleaning container 11 allows exchange of reagent containers 9 containing different reagents on one reagent line 8. In other words, reagent assays become interchangeable without changing parts of instruments, like fluid lines 2, 8 or fluidic connections 15. The fluidic system 1 no longer has fixed reagent channels. Furthermore, in case reagent lines 8 are clogged, wash fluid from the cleaning container 11 can help unblocking the fluid line by use of, e.g., aggressive wash agents.

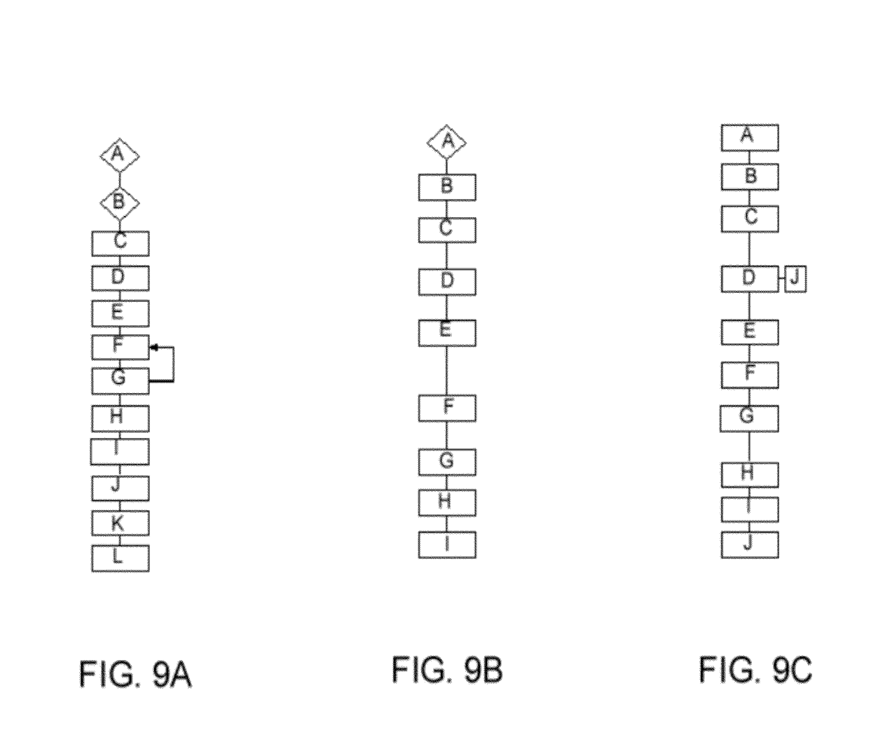

With particular reference to FIGS. 9A through 9C illustrating different workflow diagrams various exemplary wash processes are explained.

Referring to FIG. 9A, a first workflow diagram (flowchart) related to an exchange of reagent containers 9 containing different reagents in an analytical instrument is explained.

| | |
|---|---|
| A: 1 | User decisions: new assay type |
| | (parameter) should be measured on |
| | system. User requests reagent change |
| | via software GUI |
| B: 2 | Software asks for channel number |
| | (reagent slot) to be replaced. |
| | User selects slot. |
| C: Wash | Instrument washes connection channel |
| | (reagent line) with wash solution |
| | (e.g., system water). Wash solution is |
| | pushed into reagent container, |
| | which was chosen to be replaced. |
| D: Out | User takes away reagent container, |
| | either manually directly from |
| | reagent slot, or instrument transfers |
| | cassette to an output position. |
| E: Load | User loads cleaning container on |
| | the instrument. |
| F: Wash | Instrument draws out wash solution |
| | from cleaning container and cleans |
| | residue of the exchanged reagent |
| | from reagent line. |
| G: Waste | Used wash solution is wasted into |
| | instrument waste or pushed back |
| | into cleaning container (in case of |
| | wash/waste cleaning container). Last |
| | two steps are repeated until needed |
| | cleanness is reached. |
| H: Water | System water is used to clean system |
| | and reagent line from wash |
| | reagent. Water waste is pushed into |
| | system waste or cleaning container. |
| I: Drv | System empties reagent line with air |
| | which is pushed into cleaning container. |
| J: IO | User takes away cleaning container and |
| | loads new reagent container onto the |
| | instrument. |
| K: Prime | Instrument draws new reagent fluid from |
| | reagent container into reagent line. |
| | Line valve at the end of the reagent line is |
| | closed upon contact with the reagent. |
| L: End | New reagent container is loaded and |
| | ready for first usage. |

Referring to FIG. 9B, a second workflow diagram (flowchart) related to a maintenance procedure in case a reagent line has not been used for a longer time period (conditioning of the fluid paths) is explained.

| | |
|---|---|
| A: 1 | User decisions: System is powered on or |
| | conditioning is passively or actively requested. |
| B: IO | User loads cleaning container or cleaning |
| | container is loaded automatically by the |
| | system from storage. |
| C: Prime | Instrument primes reagent containers by |
| | pulling out reagent from each container into |
| | the reagent line. Flow is stopped as soon |
| | as the reagent reaches the line valve |
| | at the end of the reagent line. |
| D: Wash | The main line is washed with wash fluid |
| | from the cleaning container by pumping wash |
| | fluid through the line network. |
| E: Cond | Conditioning takes place by pumping a |
| | conditioning fluid through the system, the |
| | conditioning fluid is contained |
| | in the cleaning container (within a second |
| | compartment) or as a reagent (in form of |
| | a reagent container) provided to the |
| | system. The conditioning changes positively |
| | the surface properties of the fluid lines, |
| | e.g., reducing unwanted |
| | deposits (particles, molecules). |
| F: Water | System water is used to clean the system |
| | from wash reagent and excess conditioning fluid. |
| | Liquid waste is pushed into system waste or |
| | cleaning container. |
| G: Drv | System empties reagent line with air which |
| | is pushed into cleaning container or |
| | system waste. |
| H: IO | User takes away cleaning container or |
| | instrument moves cleaning container into |
| | storage. |
| I: End | Instrument is ready for analysis. |

Referring to FIG. 9C, a third workflow diagram (flowchart) related to harsh wash against clogs and clots is explained.

| | |
|---|---|
| A: Stop | Pressure or flow sensor detects blockage. Current |
| | instrument activity is stopped. |
| B: SW | Software localizes affected fluid path. All line |
| | valves in fluid path are opened. |
| C: Wash | Instrument washes affected fluid line with |
| | on-board wash solution (e.g., system water). Wash |
| | solution is pushed and pulled forth and back to |
| | unblock the fluid line. Used wash solution is |
| | pushed into waste container or system waste. |
| D: Water | System water is used to clean the system from |
| | wash reagent. Water waste is pushed into system |
| | waste or waste container. System water is used |
| | to test for free flow. If wash process was successful, |
| | process ends here, if not special harsh wash |
| | with external cleaning container is initiated. |
| E: WII | Instrument prompts for cleaning container with |
| | special harsh chemicals (e.g., acid or bases). |
| F: IO | User puts special cleaning container on instrument |
| | or instrument moves special cleaning container |
| | from cassette storage into an active position. |
| G: WIII | Wash subroutine is started as previously described. |
| | Special wash reagent is brought into contact with |
| | blocked flow channel part and actively, |
| | by pumping, or passively, by diffusion, the harsh |
| | cleaner unblocks the passage. |
| H: Water | Fluid lines are cleaned from wash chemicals with |
| | water rinsing and followed by air drying. |
| I: IO | User takes away cleaning container or cleaning |
| | container is moved by the system automatically |
| | into the storage. |
| J: End | System is ready for next step. |

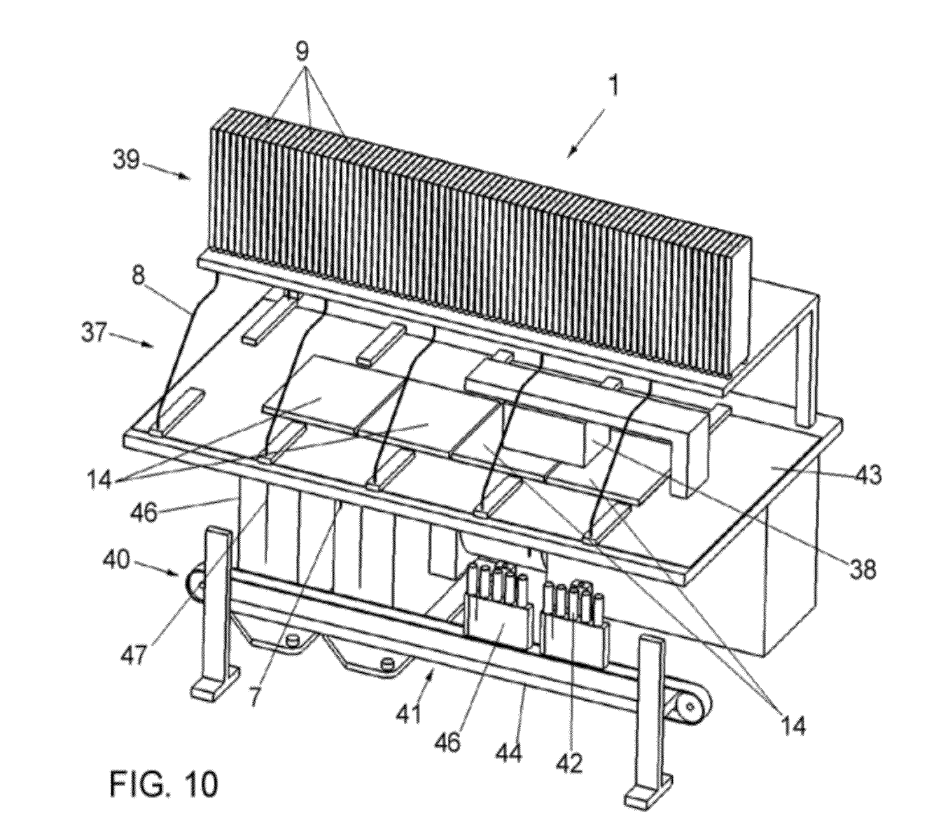

With particular reference to FIG. 10, an exemplary embodiment of the fluidic system 1 is explained. Accordingly, the fluidic system 1 includes a plurality of (flow-through) processing units 14 adapted for the processing of liquid samples, each of which being a functional and structural entity of the system 1. The system 1 further comprises an analytical unit 37 which includes an optical detector 38 which, e.g., may be embodied as photometer. The processing units 14, together with the analytical unit 37 including the optical detector 38, are dedicated to a same type of analytical method which, e.g., can be related to clinical chemistry, immune chemistry, nucleic acid testing, haematology, urinalysis and the like according to the specific demands of the user. The system 1 further comprises a reagent unit 39 provided with plural reagent containers 9, e.g., stored in a cooled compartment which contain reagents for combining with the samples. The reagents may be identical or different with respect to each other. The system 1 yet further comprises a sample unit 40 equipped with a sample tube loading mechanism 41 for loading sample tubes 42 into the system 1 and transporting the sample tubes 42 to the various processing units 14. The system 1 yet further comprises a distribution unit 43 for distributing one or more reagents provided with plural distribution (flow) channels for transporting reagents and optionally samples to each of the processing units 14. The sample tube loading mechanism 41 is embodied as a belt drive including a motor-driven belt 44, adapted for transporting a plurality of sample tube racks 46 holding the sample tubes 42.

The analytical unit 37 further includes one flow-through cell 46 coupled to an instrument to detect light emitted from reaction products of sample and one or more reagents transferred to the flow-through cell 46. The optical detector 38 is coupled to a first subset of processing units 14 while the flow-through cell 46 is fluidically connected to a second subset of processing units 14 by manifold connecting channel 47. The optical detector 38 and the flow-through cell 46 are related to different types of analytical methods.

In the system 1, the distribution unit 43 is a planar body which has a plate-like shape. It is provided with a plurality of fluid lines or channels (not shown) for transporting fluids. The distribution or main channels are connected to the reagent containers 9 by means of reagent lines 8 so as to connect each of the reagent containers 9 to individual distribution channels. Each of the processing units 14 is fluidically connected to an individual sample intake 7, e.g., embodied as a metallic needle. Each of the sample intakes 7 can be dipped into the sample tubes 43, e.g., by lifting the sample tubes 43 for aspirating sample contained therein.

As illustrated in FIG. 10, the reagent unit 39, the analytical unit 37 and the sample unit 40 are arranged in different vertical heights (levels) with the reagent unit 39 being above the analytical unit 37 and the sample unit 40 being below the analytical unit 37. Accordingly, in the system 1, reagent containers 9 can be readily replaced. Each of the units of the system 1 is a functional and structural entity and, e.g., is embodied as a modular unit.

The various embodiments of the present invention thus have many advantages over the prior art. It allows cleaning of fluid lines with a non-permanent connection of the wash agent to the fluidic system. Multiple non-permanent cleaners are available on-board. The embodiments especially allow cleaning from the reagent side and not only the system side. Due to the possibility to clean the reagent lines, carry-over which could be caused by a reagent exchange can be avoided. The wash fluids can be drawn from the cleaning container into the fluidic lines and can also be discharged back to the cleaning container. Otherwise, wash fluid can be discharged via the sample intake and through the fluid waste port. Since the cleaning container has the same outer dimensions as the reagent containers, any reagent container can readily be exchanged with the cleaning container.

It is noted that terms like “typically” are not utilized herein to limit the scope of the claimed subject matter or to imply that certain features are critical, essential, or even important to the structure or function of the embodiments disclosed herein. Rather, these terms are merely intended to highlight alternative or additional features that may or may not be utilized in a particular embodiment.

It is also noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modifications and variations come within the scope of the appended claims and their equivalents.

What is claimed is:

1. A process for automatically washing fluid lines of a fluidic system for combining liquid samples with one or more reagents, said system comprising:
at least one main line connected to one or more reagent lines configured for feeding reagents, each said reagent line being connectable to a reagent container by a fluidic connector,
at least one sample intake configured for intaking samples and at least one pressure actuator configured for generating a positive or negative pressure in said fluid lines, wherein said process comprises the steps of one or more procedures selected from the group of procedures consisting of:
procedure I: drawing wash fluid from a wash fluid reservoir, connected to said main line, into said main line, and discharging wash fluid into a waste compartment for receiving waste fluid of a cleaning container, connected to at least one reagent line by said fluidic connector;
procedure II: drawing wash fluid from at least one fluid compartment containing wash fluid of at least one cleaning container, said cleaning container connected to at least one reagent line by said fluidic connector, into said main line, and discharging wash fluid from said main line into at least one waste compartment for receiving waste fluid of said cleaning container;
procedure III: drawing wash fluid from at least one fluid compartment containing wash fluid of a cleaning container, said cleaning container connected to at least one first reagent line, into said main line, and discharging wash fluid from said main line into at least one waste compartment for receiving waste fluid of a cleaning container connected to at least one second reagent line being different from said at least one first reagent line.

2. The process according to claim 1, wherein in each of procedures II and III plural wash fluids different with respect to each other contained in plural fluid compartments are successively drawn into said main line.

3. The process according to claim 1, wherein wash fluid is discharged through said sample intake.

4. The process according to claim 1, wherein at least one reagent container connected to one reagent line is automatically replaced with one cleaning container.

5. A process for automatically washing fluid lines of a fluidic system for combining liquid samples with one or more reagents, said system comprising:
at least one main line connected to one or more reagent lines configured for feeding reagents, each of which being connectable to a reagent container by a fluidic connector,
at least one sample intake configured for intaking samples and at least one pressure actuator configured for generating a positive or negative pressure in said fluid lines, wherein said process comprises the steps of:
connecting at least one cleaning container provided with at least one fluid compartment containing wash fluid to at least one reagent line,
drawing wash fluid from said fluid compartment into said main line, and
discharging wash fluid from said main line through a waste fluid port of said main line.

6. A cleaning container for connection by at least one fluidic connector to at least one reagent line of a fluidic system for combining liquid samples with reagents, comprising:
at least one waste compartment configured for receiving waste fluid and/or at least one fluid compartment containing wash fluid; and
at least one container-sided connector part configured for connection to a reagent line-sided connector part of said reagent line, configured for forming said fluidic connector.

7. The cleaning container according to claim 6 further comprising at least one fluid valve configured to release or inhibit fluid flow between said reagent line and one or more compartments in one or both flow directions.

8. The cleaning container according to claim 6, wherein said container-sided connector part comprises a septum closing a fluid opening, said septum being configured to be broken by a protruding element of said reagent line-sided connector part.

9. The cleaning container according to claim 8, wherein said septum is positioned nearer to said fluid opening than a septum of a similar container-sided connector part of a reagent container for connection to said reagent line.

10. A fluidic system for combining liquid samples with one or more reagents, comprising:
a main line connected to a wash fluid reservoir;
plural reagent lines connected to said main line configured for feeding reagents, each of which being connectable to a reagent container by a fluidic connector;
at least one sample intake connected to said main line configured for intaking samples;
at least one pressure actuator configured for generating a positive or negative pressure in said fluid lines;
one or more reagent containers, each of which being connected to one reagent line by said fluidic connector;
at least one cleaning container provided with at least one waste compartment configured for receiving waste fluid connected to at least one reagent line by said fluidic connector; and
a controller configured to draw wash fluid from said wash fluid reservoir into said main line and to discharge wash fluid from said main line into said waste compartment.

11. A fluidic system for combining liquid samples with one or more reagents, comprising:
a main line;
plural reagent lines connected to said main line configured for feeding reagents, each of which being connectable to a reagent container by a fluidic connector;
at least one sample intake connected to said main line, configured for intaking samples;
at least one pressure actuator, configured for generating a positive or negative pressure in said fluid lines;
one or more reagent containers, each of which being connected to one reagent line by said fluidic connector;
at least one cleaning container provided with at least one waste compartment, configured for receiving waste fluid, and at least one fluid compartment containing wash fluid connected to at least one reagent line; and
a controller configured to draw wash fluid from said fluid compartment into said main line and to discharge wash fluid from said main line into said waste compartment.

12. The fluidic system according to claim 11, wherein said main line is connected to a wash fluid reservoir containing wash fluid, and wherein said controller is configured to draw wash fluid from said wash fluid reservoir into said main line and to discharge wash fluid from said main line into at least one waste compartment.

13. The fluidic system according to claim 11, wherein said cleaning container comprises plural fluid compartments containing wash fluids different with respect to each other, and wherein said controller is configured to selectively draw said wash fluids into said main line.

14. The fluidic system according to claim 10, wherein said main line is connected to a waste fluid port, and wherein said controller is configured to discharge wash fluid through said waste fluid port.

15. The fluidic system according to claim 10 further comprising an automated positioning mechanism configured for positioning individual containers, wherein said controller is configured to replace at least one reagent container connected to one reagent line with said cleaning container.
